(19) United States
(12) Patent Application Publication
(10) Pub. No.: US 2026/0104076 A1
(43) Pub. Date: Apr. 16, 2026

(54) CLUTCH DEVICE

(71) Applicant: EXEDY Corporation, Osaka (JP)

(72) Inventor: Toshiki FUNADA, Osaka (JP)

(21) Appl. No.: 19/328,570

(22) Filed: Sep. 15, 2025

(30) Foreign Application Priority Data
Oct. 11, 2024 (JP) 2024-178621

(51) Int. Cl. F16D 13/56; F16D 13/64; F16D 13/70

(52) U.S. Cl. CPC F16D 13/56; F16D 13/648; F16D 13/70

(57) ABSTRACT

A clutch device to limit transmission of back torque includes a first rotary member, a second rotary member, a first friction plate, a second friction plate, and a plurality of friction materials. The second rotary member is disposed to be rotatable relative to the first rotary member. The first friction plate is configured to be rotated unitarily with the first rotary member. The second friction plate is configured to be rotated unitarily with the second rotary member. The plurality of friction materials are fixed to the first friction plate. The plurality of friction materials are aligned in a circumferential direction and each includes a planar portion and a slope portion. The planar portion is in contact with the second friction plate. The slope portion slants to face an axial direction and to face a direction that the first friction plate is rotated relative to the second friction plate in deceleration.

### CROSS-REFERENCE TO RELATED APPLICATIONS

This application is based on and claims the priority benefit of Japanese Application No. 2024-178621 filed on October 11, 2024, the contents of which are incorporated herein by reference.

### TECHNICAL FIELD

The present invention relates to a clutch device.

### BACKGROUND

Straddled vehicles (e.g., a two-wheeled motorcycle) include a clutch device. The clutch device is configured to allow and block the transmission of mechanical power generated by a prime mover (e.g., an internal combustion engine) to one or more drive wheels. In the clutch device, torque transmission is made between a drive plate rotated unitarily with a clutch housing and a driven plate rotated unitarily with a clutch center (Japan Laid-open Patent Application Publication No. 2024-051103).

### SUMMARY OF THE INVENTION

When decelerating by downshifting, the vehicle body stability of a straddled vehicle can deteriorate due to an excessive back torque transmitted from the drive wheel or wheels to the prime mover. Because of this, it is desirable to limit transmission of the excessive back torque. In view of this, it is an object of the present invention to limit transmission of the excessive back torque.

A clutch device according to a first aspect relates to a clutch device for a straddled vehicle. The clutch device includes a first rotary member, a second rotary member, a first friction plate, a second friction plate, and a plurality of friction materials. The second rotary member is disposed to be rotatable relative to the first rotary member. The first friction plate is configured to be rotated unitarily with the first rotary member. The second friction plate is configured to be rotated unitarily with the second rotary member. The plurality of friction materials are fixed to the first friction plate. The plurality of friction materials are aligned in a circumferential direction. The plurality of friction materials each include a planar portion and a slope portion. The planar portion is in contact with the second friction plate. The slope portion slants not only to face an axial direction but also to face a direction that the first friction plate is rotated relative to the second friction plate in deceleration of the straddled vehicle.

When the clutch device receives a back torque, the first friction plate is rotated relative to the second friction plate, whereby an oil, residing between the friction materials, is led to a space between the planar portion of each friction material and the second friction plate by the slope portion. As a result, the oil intrudes into the space between each friction material and the second friction plate, whereby slippage is caused between the first friction plate and the second friction plate. Consequently, it is made possible to limit transmission of an excessive back torque.

A clutch device according to a second aspect relates to the clutch device according to the first aspect and is configured as follows. The slope portion slants to face radially inward as well. According to the configuration, it is made possible to feed the oil as much as possible to the space between each friction material and the second friction plate.

A clutch device according to a third aspect relates to the clutch device according to the first or second aspect and is configured as follows. The slope portion has a circumferential dimension reducing radially outward.

A clutch device according to a fourth aspect relates to the clutch device according to any of the first to third aspects and is configured as follows. Each adjacent pair of friction materials in the plurality of friction materials is disposed away from each other at an interval widened radially outward.

A clutch device according to a fifth aspect relates to the clutch device according to any of the first to fourth aspects and is configured as follows. The slope portion is smaller in surface roughness than the planar portion. According to the configuration, it is made easy to feed the oil to the space between each friction material and the second friction plate.

A clutch device according to a sixth aspect relates to the clutch device according to any of the first to fifth aspects and is configured as follows. The plurality of friction materials are each larger in radial dimension than in circumferential dimension.

A clutch device according to a seventh aspect relates to the clutch device according to any of the first to sixth aspects and further includes a third rotary member. The third rotary member includes a pressure applying surface. The third rotary member is disposed to be movable with respect to the second rotary member in the axial direction. The second rotary member includes a pressure receiving surface. The first friction plate and the second friction plate are disposed between the pressure applying surface and the pressure receiving surface in the axial direction.

A clutch device according to an eighth aspect relates to the clutch device according to the seventh aspect and is configured as follows. The third rotary member includes a cylindrical portion. The cylindrical portion extends in the axial direction. The second rotary member includes a pillar portion. The pillar portion extends inside the cylindrical portion in the axial direction.

A clutch device according to a ninth aspect relates to the clutch device according to the eighth aspect and further includes a coil spring. The coil spring urges the third rotary member such that the pressure applying surface is moved toward the pressure receiving surface. The coil spring is disposed inside the cylindrical portion. The pillar portion extends inside the coil spring.

A clutch device according to a tenth aspect relates to the clutch device according to the ninth aspect and further includes a support plate. The support plate is attached to the pillar portion. The cylindrical portion includes an inner flange protruding inward. The coil spring is disposed between the support plate and the inner flange.

Overall, according to the present invention, it is made possible to limit transmission of an excessive back torque.

### BRIEF DESCRIPTION OF THE DRAWINGS

FIG. 1 is a plan view of a clutch device.

FIG. 2 is a cross-sectional view of the clutch device taken along line II-II in FIG. 1.

FIG. 3 is a plan view of a drive plate.

FIG. 4 is a perspective view of the drive plate.

FIG. 5 is a cross-sectional view for showing oil flow in deceleration.

FIG. 6 is a cross-sectional view for showing oil flow in deceleration in a modification.

FIG. 7 is a perspective view for showing friction materials in another modification.

### DETAILED DESCRIPTION

A clutch device 100 according to the present preferred embodiment will be hereinafter explained with reference to drawings. It should be noted that in the following explanation, the term “axial direction” refers to an extending direction of a rotational axis O of the clutch device 100. On the other hand, the term “circumferential direction” refers to a circumferential direction of an imaginary circle about the rotational axis O, whereas the term “radial direction” refers to a radial direction of the imaginary circle about the rotational axis O. A forward rotational direction R1 refers to a direction in which the clutch device 100 is rotated in forward traveling of a vehicle that the clutch device 100 is installed, whereas a reverse rotational direction R2 refers to a rotational direction oriented reverse to the forward rotational direction R1.

### Clutch Device

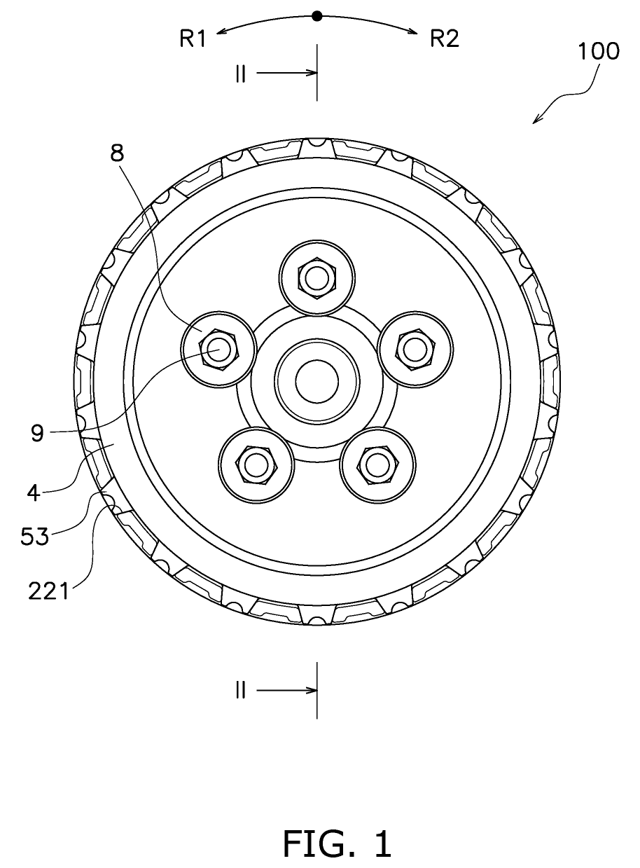

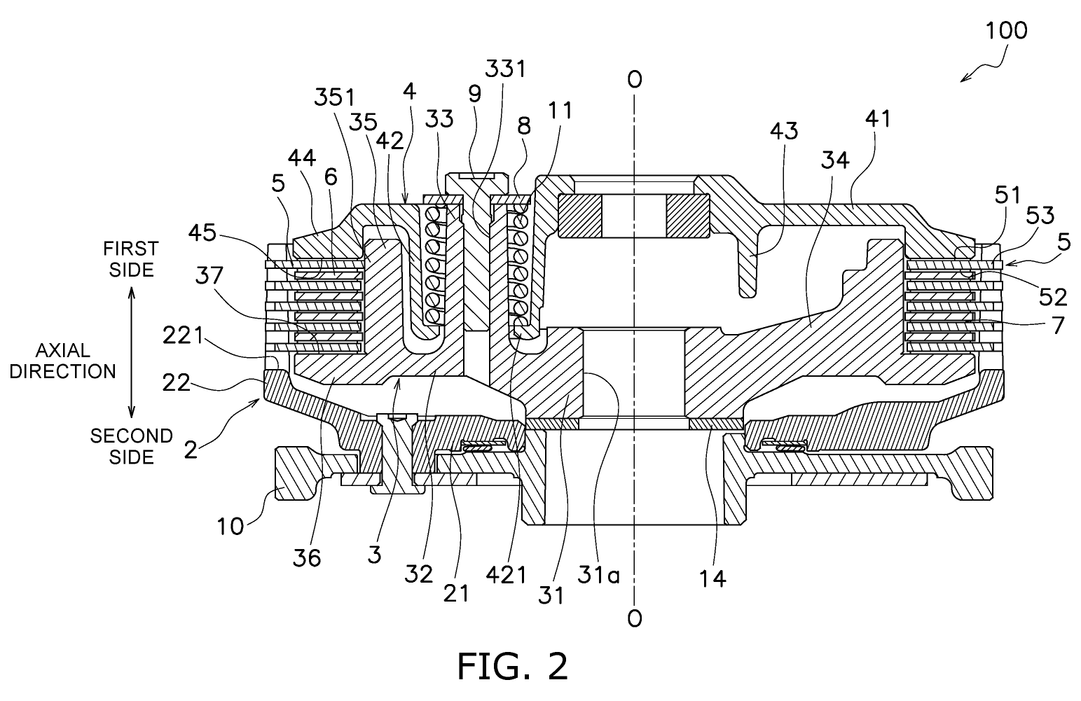

FIG. 1 is a plan view of the clutch device 100, whereas FIG. 2 is a cross-sectional view of the clutch device 100 taken along line II-II in FIG. 1. As shown in FIGS. 1 and 2, the clutch device 100 is configured to allow and block the transmission of mechanical power generated by a prime mover (e.g., an internal combustion engine) to one or more drive wheels. The clutch device 100 is configured to transmit the mechanical power in the forward rotational direction R1 (counterclockwise in FIG. 1). The clutch device 100 is configured to be rotatable. Specifically, the clutch device 100 is rotated about the rotational axis O in the forward rotational direction R1.

The clutch device 100 includes a clutch housing 2 (exemplary first rotary member), a clutch center 3 (exemplary second rotary member), a pressure plate 4 (exemplary third rotary member), a plurality of drive plates 5 (exemplary first friction plate), a plurality of driven plates 6 (exemplary second friction plate), and a plurality of friction materials 7.

Additionally, the clutch device 100 includes a plurality of support plates 8, a plurality of bolts 9, and a plurality of coil springs 11. It should be noted that the clutch device 100 does not include a cam mechanism. Specifically, although not included in the clutch device 100, the cam mechanism is configured as follows if included therein: when the clutch center 3 and the pressure plate 4 are rotated relative to each other in acceleration or deceleration of a vehicle, the cam mechanism converts a force acting in the relative rotational direction into a force for moving the pressure plate 4 in the axial direction. It should be noted that the clutch device 100 may include the cam mechanism.

### Clutch Housing

The clutch housing 2 is disposed to be rotatable about the rotational axis O. The clutch housing 2 includes a disc portion 21 and a tubular portion 22. The clutch housing 2 is coupled to an input gear 10. The input gear 10 is an annular member to which the mechanical power, generated by the prime mover, is inputted. The input gear 10 is meshed with a drive gear (not shown in the drawings) fixed to a prime mover-side crankshaft.

The disc portion 21 is coupled to the input gear 10 through a plurality of coil springs (omitted in illustration). The tubular portion 22 extends from the outer peripheral edge of the disc portion 21 to a first side in the axial direction. The tubular portion 22 includes a plurality of cutouts 221 extending in the axial direction. The cutouts 221 are disposed away from each other at intervals in the circumferential direction.

### Clutch Center

The clutch center 3 is disposed to be rotatable about the rotational axis O. The clutch center 3 is disposed to be rotatable relative to the clutch housing 2. The clutch center 3 is disposed on the first side of the clutch housing 2 in the axial direction. Moreover, the clutch center 3 is disposed radially inside the tubular portion 22 of the clutch housing 2. In other words, the clutch center 3 is disposed to be enclosed by the clutch housing 2. The clutch center 3 is disposed to be immovable in the axial direction.

The clutch center 3 includes a boss portion 31, a first base portion 32, a plurality of pillar portions 33, a plurality of ribs 34, a first cylindrical portion 35, a flange portion 36, and a pressure receiving surface 37.

The boss portion 31 extends in the axial direction. The boss portion 31 has a cylindrical shape. The boss portion 31 includes a spline hole 31a, extending in the axial direction, in the middle part thereof. An input shaft of a transmission or so forth (omitted in illustration) is spline-coupled to the spline hole 31a. A thrust plate 14 is provided between the boss portion 31 and the input gear 10 in the axial direction.

The first base portion 32 extends radially outward from the outer peripheral surface of the boss portion 31. The first base portion 32 is made in the shape of an annulus extending in the circumferential direction. The first base portion 32 is disposed radially outside the boss portion 31. The first base portion 32 is joined to the first cylindrical portion 35.

The pillar portions 33 extend from the first base portion 32 to the first side in the axial direction. Each pillar portion 33 has a cylindrical shape. Each pillar portion 33 includes a threaded through hole 331 penetrating therethrough in the axial direction.

The ribs 34 are provided on the first base portion 32. The ribs 34 extend in the radial directions. The ribs 34 couple the boss portion 31 and the first cylindrical portion 35 therethrough to each other. Each rib 34 slants to increase in height radially outward. The ribs 34 and the pillar portions 33 are alternately disposed in the circumferential direction.

The first cylindrical portion 35 extends in the axial direction. The first cylindrical portion 35 includes a plurality of external teeth 351. The external teeth 351 are provided on the outer peripheral surface of the first cylindrical portion 35. The external teeth 351 each extend in the axial direction. The external teeth 351 are disposed away from each other at intervals in the circumferential direction.

The first cylindrical portion 35 includes at least one through hole (omitted in illustration). The at least one through hole penetrates the first cylindrical portion 35 in the radial direction. The at least one through hole extends in the axial direction. An oil to be supplied to a space radially inside the cylindrical portion 35 is supplied through the at least one through hole to the drive plates 5 and the driven plates 6, both of which are disposed radially outside the first cylindrical portion 35.

The flange portion 36 extends radially outward from the first cylindrical portion 35. When described in detail, the flange portion 36 extends radially outward from one axial end of the first cylindrical portion 35, i.e., the end thereof disposed on a second side in the axial direction. The surface of the flange portion 36, facing the first side in the axial direction, is provided as the pressure receiving surface 37. In other words, the pressure receiving surface 37 faces the first side in the axial direction. The pressure receiving surface 37 is made in the shape of an annulus extending in the circumferential direction. The pressure receiving surface 37 is disposed on the outer peripheral part of the clutch center 3.

### Pressure Plate

The pressure plate 4 is disposed to be movable in the axial direction. In other words, the pressure plate 4 is movable relative to the clutch center 3 in the axial direction. The pressure plate 4 is disposed to be rotatable about the rotational axis O. The pressure plate 4 is disposed between the clutch center 3 and the support plate 8 in the axial direction.

The pressure plate 4 includes a second base portion 41, a plurality of second cylindrical portions 42 (exemplary cylindrical portion), a plurality of joining portions 43, a second flange portion 44, and a pressure applying surface 45.

The second base portion 41 has a disc shape and includes an opening in the middle part thereof. A release mechanism (omitted in illustration) is configured to be attached to the opening of the second base portion 41.

The second cylindrical portions 42 extend from the second base portion 41 to the second side in the axial direction. In other words, the second cylindrical portions 42 extend from the second base portion 41 toward the first base portion 32 of the clutch center 3. The pillar portions 33 extend inside the second cylindrical portions 42, respectively.

Each second cylindrical portion 42 includes an inner flange 421, protruding inward, in the distal end thereof. The inner flange 421 has an annular shape. The inner flange 421 is configured to support each coil spring 11.

The joining portions 43 protrude from the second base portion 41 to the second side in the axial direction. Each joining portion 43 circumferentially extends such that each adjacent pair of second cylindrical portions 42 is coupled therethrough to each other.

The second flange portion 44 is disposed radially outside the second base portion 41. The surface of the second flange portion 44, facing the second side in the axial direction, is provided as the pressure applying surface 45. In other words, the pressure applying surface 45 faces the second side in the axial direction. The pressure applying surface 45 is made in the shape of an annulus extending in the circumferential direction. The pressure applying surface 45 is disposed on the outer peripheral part of the pressure plate 4.

The pressure applying surface 45 is disposed on the first side of the pressure receiving surface 37 in the axial direction. The pressure applying surface 45 overlaps with the pressure receiving surface 37 as seen in the axial direction.

### Drive Plates and Driven Plates

The drive plates 5 and the driven plates 6 are disposed between the pressure receiving surface 37 and the pressure applying surface 45. The drive plates 5 and the driven plates 6 are alternately disposed in the axial direction. Not only each drive plate 5 but also each driven plate 6 is made in the shape of an annulus extending in the circumferential direction.

Each drive plate 5 includes a first surface 51 and a second surface 52. The first surface 51 refers to a surface facing the first side in the axial direction. The second surface 52 refers to a surface facing the second side in the axial direction.

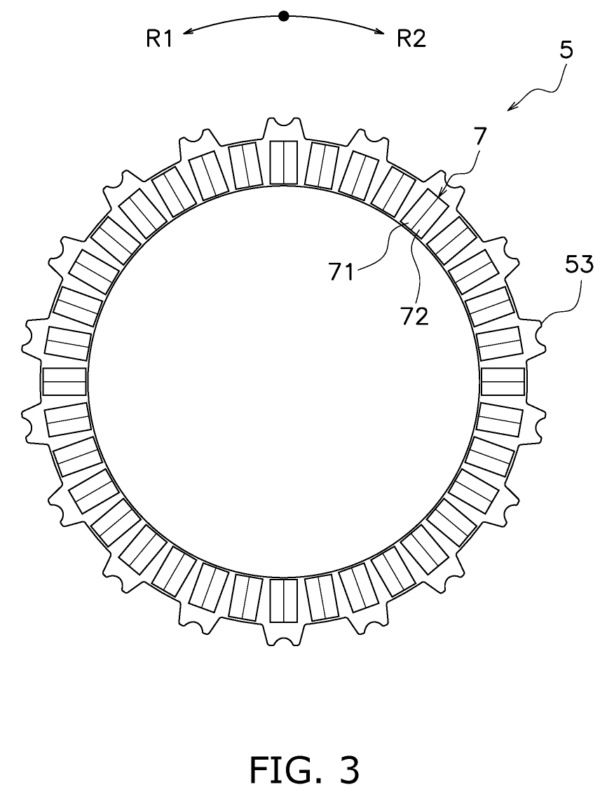

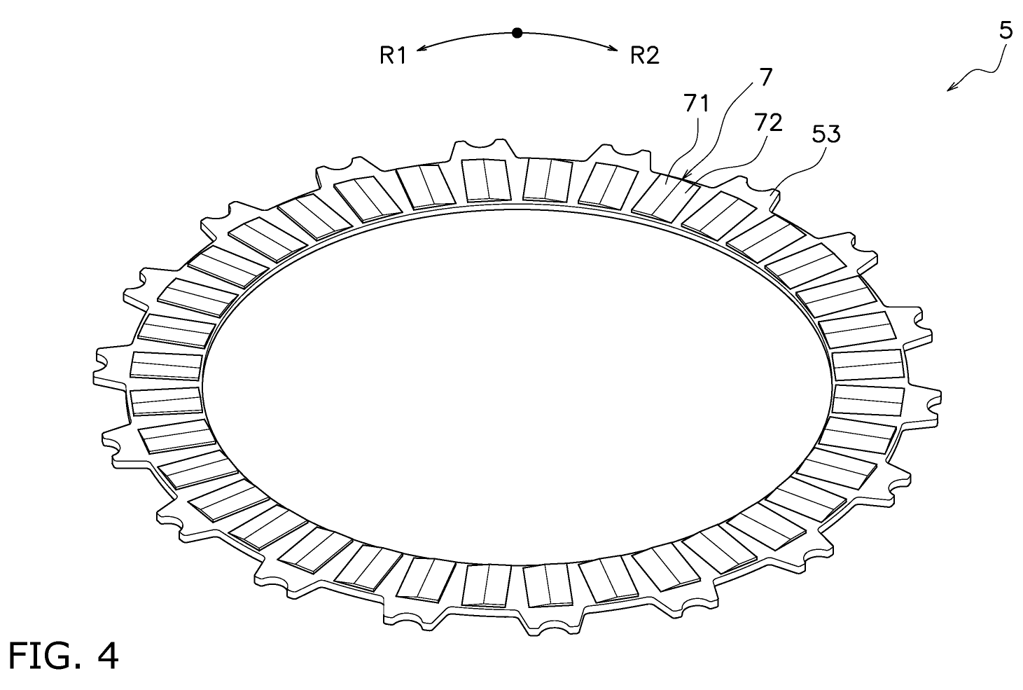

FIG. 3 is a plan view of each drive plate 5, whereas FIG. 4 is a perspective view of each drive plate 5. As shown in FIGS. 2 to 4, the drive plates 5 are axially movable with respect to the clutch housing 2, while being non-rotatable relative thereto. The drive plates 5 are rotated unitarily with the clutch housing 2. When described in detail, each drive plate 5 includes a plurality of engaging protrusions 53 that protrude radially outward. The engaging protrusions 53 are meshed with cutouts 221 provided in the tubular portion 22 of the clutch housing 2.

Each driven plate 6 includes a plurality of internal teeth (omitted in illustration). The internal teeth are meshed with the external teeth 351, respectively. Accordingly, each driven plate 6 is axially movable with respect to the first cylindrical portion 35, while being non-rotatable relative thereto. The driven plates 6 are rotated unitarily with the clutch center 3.

### Friction Materials

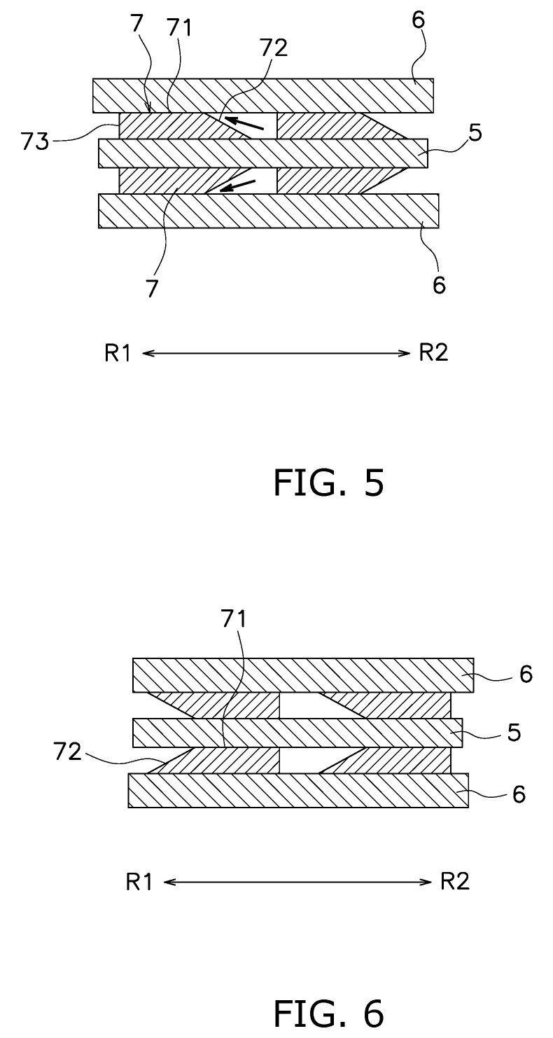

FIG. 5 is a cross-sectional view for showing oil flow in deceleration. As shown in FIGS. 3 to 5, the friction materials 7 are fixed to each drive plate 5. When described in detail, the friction materials 7 are adhered to each drive plate 5. The friction materials 7 are disposed circumferentially away from each other at intervals on the first surface 51 of each drive plate 5. Likewise, the friction materials 7 are disposed circumferentially away from each other at intervals on the second surface 52 of each drive plate 5 as well. The friction materials 7 disposed on the first surface 51 of each drive plate 5 and those disposed on the second surface 52 of each drive plate 5 are identical in circumferential position to each other. In other words, the friction materials 7 disposed on the first surface 51 of each drive plate 5 and those disposed on the second surface 52 of each drive plate 5 overlap with each other as seen in the axial direction.

Each friction material 7 is made of, for instance, paper material or cork.

Each friction material 7 has a rectangular shape as seen in the axial direction. Each friction material 7 is larger in radial dimension than in circumferential dimension. Each adjacent pair of friction materials 7 is disposed away from each other at an interval gradually widened radially outward.

Each friction material 7 includes a planar portion 71 and a slope portion 72. Regarding each of the friction materials 7 disposed on the first surface 51 of each drive plate 5, the planar portion 71 extends substantially in parallel to the first surface 51 of each drive plate 5. Likewise, regarding each of the friction materials 7 disposed on the second surface 52 of each drive plate 5, the planar portion 71 extends substantially in parallel to the second surface 52 of each drive plate 5. The planar portion 71 is in contact with the driven plate 6 adjacent thereto. In other words, torque transmission is made by each friction material 7 through the planar portion 71 thereof.

The slope portion 72 slants with respect to the planar portion 71. Regarding each of the friction materials 7 disposed on the first surface 51 of each drive plate 5, the slope portion 72 slants with respect to the first surface 51. Likewise, regarding each of the friction materials 7 disposed on the second surface 52 of each drive plate 5, the slope portion 72 slants with respect to the second surface 52.

The slope portion 72 slants not only to face the axial direction but also to face the reverse rotational direction R2. In other words, the slope portion 72 slants to face the direction that the drive plates 5 are rotated relative to the driven plates 6 in deceleration. The slope portion 72 extends from the planar portion 71 toward either the first surface 51 or the second surface 52.

The slope portion 72 can be set to be smaller in surface roughness than the planar portion 71. The term “surface roughness” herein means arithmetic average roughness Ra. It should be noted that the slope portion 72 may be equal in surface roughness to the planar portion 71, or alternatively, may be larger in surface roughness than the planar portion 71.

It should be noted that, amongst the lateral surfaces of each friction material 7, a lateral surface 73 faces the opposite side of the side that the slope portion 72 circumferentially faces, in other words, faces the forward rotational direction R1, and extends vertically with respect to either the first surface 51 or the second surface 52.

### Support Plate

As shown in FIGS. 1 and 2, the support plates 8 are aligned in the circumferential direction. The support plates 8 are disposed on the first side of the clutch center 3 in the axial direction. The support plates 8 are attached to the distal ends (the upper ends in FIG. 2) of the pillar portions 33, respectively. When described in detail, the support plates 8 are fastened to the clutch center 3 by the bolts 9, respectively. Because of this, the support plates 8 are rotated unitarily with the clutch center 3.

### Coil Springs

The coil springs 11 are circumferentially disposed in identical positions to the pillar portions 33, respectively. When described in detail, each pillar portion 33 extends inside each coil spring 11. Each coil spring 11 is disposed in each second cylindrical portion 42. Each coil spring 11 is disposed in a compressed state between each support plate 8 and the inner flange 421 of each second cylindrical portion 42.

The coil springs 11 urge the pressure plate 4 to the second side in the axial direction. Because of this, the pressure applying surface 45 is urged to approach to the pressure receiving surface 37; accordingly, the clutch device 100 is turned to a clutch-on state, whereby transmission of the mechanical power is allowed between the clutch housing 2 and the clutch center 3. It should be noted that, when the pressure plate 4 is moved by a release member to the first side in the axial direction against the urging forces exerted by the coil springs 11, the pressure applying surface 45 is moved to separate from the pressure receiving surface 37. As a result, the clutch device 100 is turned to a clutch-off state, whereby transmission of the mechanical power is blocked between the clutch housing 2 and the clutch center 3.

### Actions

As shown in FIG. 5, especially when an operation of downshifting gears is performed in deceleration or so forth, the driven plates 6, to which a torque is transmitted from the drive wheel side, are rotated relative to the drive plates 5 in the forward rotational direction R1. In other words, a so-called back torque, by which the drive plates 5 are caused to rotate relative to the driven plates 6 in the reverse rotational direction R2, enters the clutch device 100. Because of this, the oil, residing between each adjacent pair of friction materials 7 on each drive plate 5, flows toward a space between the planar portion 71 of a R1-side friction material 7 and each of the driven plates 6 adjacent to each drive plate 5, while being led by the slope portion 72 of the R1-side friction material 7 as depicted with each of arrows in FIG. 5. As a result, slippage is caused between the drive plates 5 and the driven plates 6, whereby it is made possible to limit transmission of the back torque to be inputted from the drive wheel side.

### Modifications

One preferred embodiment of the present invention has been explained above. However, the present invention is not limited to the above, and a variety of changes can be made without departing from the gist of the present invention. It should be noted that basically speaking, respective modifications to be described are applicable simultaneously.

In the preferred embodiment described above, the friction materials 7 are fixed to each drive plate 5; alternatively, the friction materials 7 may be fixed to each driven plate 6 as shown in FIG. 6. In this case, each drive plate 5 corresponds to the second friction plate according to the present invention, whereas each driven plate 6 corresponds to the first friction plate according to the present invention. Besides, the clutch housing 2 corresponds to the second rotary member according to the present invention, whereas the clutch center 3 corresponds to the first rotary member according to the present invention.

In this case, the slope portion 72 of each friction material 7 slants not only to face the axial direction but also to face the forward rotational direction R1. In other words, the slope portion 72 slants to face the direction that the driven plates 6 are rotated relative to the drive plates 5 in deceleration.

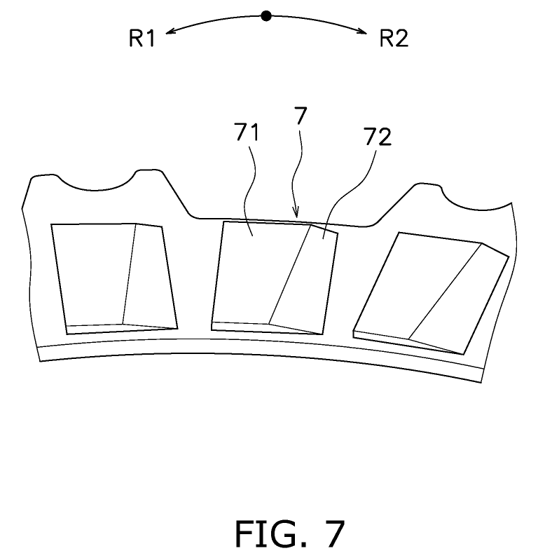

As shown in FIG. 7, the slope portion 72 of each friction material 7 may slant not only to face the axial direction and the reverse rotational direction R2 but also to face radially inward. Besides, the slope portion 72 may be set to have a circumferential dimension reducing radially outward.

### LIST OF REFERENCE NUMERALS

2: Clutch housing, 3: Clutch center, 33: Pillar portion, 4: Pressure plate, 42: Second cylindrical portion, 5: Drive plate, 6: Driven plate, 7: Friction member, 71: Planar portion, 72: Slope portion, 100: Clutch device

1. A clutch device for a straddled vehicle comprising:
a first rotary member;
a second rotary member disposed to be rotatable relative to the first rotary member;
a first friction plate configured to be rotated unitarily with the first rotary member;
a second friction plate configured to be rotated unitarily with the second rotary member; and
a plurality of friction materials fixed to the first friction plate, the plurality of friction materials aligned in a circumferential direction, wherein
the plurality of friction materials each include a planar portion and a slope portion, the planar portion being in contact with the second friction plate, the slope portion slanting not only to face an axial direction but also to face a direction that the first friction plate is rotated relative to the second friction plate in deceleration of the straddled vehicle.

2. The clutch device according to claim 1, wherein the slope portion also slants to face radially inward.

3. The clutch device according to claim 1, wherein the slope portion has a circumferential dimension reducing radially outward.

4. The clutch device according to claim 1, wherein each adjacent pair of friction materials in the plurality of friction materials is disposed away from each other at an interval widened radially outward.

5. The clutch device according to claim 1, wherein the slope portion is smaller in surface roughness than the planar portion.

6. The clutch device according to claim 1, wherein each of the plurality of friction materials is each larger in radial dimension than in circumferential dimension.

7. The clutch device according to claim 1, further comprising:
a third rotary member including a pressure applying surface, the third rotary member disposed to be movable with respect to the second rotary member in the axial direction, wherein
the second rotary member includes a pressure receiving surface, and
the first friction plate and the second friction plate are disposed between the pressure applying surface and the pressure receiving surface in the axial direction.

8. The clutch device according to claim 7, wherein
the third rotary member includes a cylindrical portion extending in the axial direction, and
the second rotary member includes a pillar portion extending inside the cylindrical portion in the axial direction.

9. The clutch device according to claim 8, further comprising:
a coil spring urging the third rotary member such that the pressure applying surface is moved toward the pressure receiving surface, wherein
the coil spring is disposed inside the cylindrical portion, and
the pillar portion extends inside the coil spring.

10. The clutch device according to claim 9, further comprising:
a support plate attached to the pillar portion, wherein
the cylindrical portion includes an inner flange protruding inward, and
the coil spring is disposed between the support plate and the inner flange.
